(19) United States
(12) Patent Application Publication
(10) Pub. No.: US 2015/0191223 A1
(43) Pub. Date: Jul. 9, 2015

(54) SHOCK ABSORPTION IN POWERBOAT SEATS

(71) Applicant: Muir ASHWORTH, (US)

(72) Inventor: Muir Ashworth, Guernsey (GB)

(21) Appl. No.: 14/410,932

(22) PCT Filed: Jun. 17, 2013
(86) PCT No.: PCT/GB2013/051576

§ 371 Date: Dec. 23, 2014

(30) Foreign Application Priority Data
Jun. 29, 2012 (GB) 1211532.5

(51) Int. Cl. B63B 29/04; B63B 9/00; B60N 2/54; B60N 2/68; B60N 2/50

(52) U.S. Cl. CPC B63B 29/04; B60N 2/686; B60N 2/502; B60N 2/544; B63B 9/00; B63B 2029/043

(57) ABSTRACT

A powerboat seat comprises a removable seat cushion supported on a seat frame. A shock-absorbing device is interposed between the seat frame and the seat cushion such that the shock-absorbing device is supported on the seat frame and the seat cushion is supported on the shock-absorbing device. The shock-absorbing device comprises an upper panel having an external face that engages the seat cushion, a lower panel having an external face that engages the seat frame, a plurality of compression springs constrained between the upper and lower panels and straps connecting the upper and lower panels to constrain the compression springs between them whilst allowing limited relative vertical movement of the upper and lower panels at the front and the back of the panels. At least some of the compression springs are located towards the front and the back of the panels.

The present invention relates to powerboats and is concerned particularly with shock absorption in the seats of powerboats.

Travel by fast powerboats can be very uncomfortable for crew and passengers, especially in rough water. The level of discomfort increases markedly when speed and wave heights increase, due to the pounding motion of the boat's hull as it skips from wave to wave. Boat seats and their cushions are usually lined with foam in an attempt to reduce shock loading. However, foam is not well suited to this requirement so, although aesthetically pleasing, it has little or no effect on softening the jarring motion of a fast boat.

Crew comfort is a major consideration with boat design; a boat's hull shape has major effect on its motion through water. On fast powerboats, the softness of the ride is influenced by the hulls deadrise; as this increases, ride comfort improves marginally (even so, ride impact on boat occupants can still be considerable); however, this is accompanied by an increasing power requirement and lower fuel efficiency for a given speed, due to greater wetted hull area. Increasing deadrise is therefore an unattractive option for designers and consequently uncommon in mainstream powerboats.

Considerable attention has been paid to providing shock absorbing seats and floors in boats. Examples of these can be found in US 2011/049775 (Crumley), US2009064916 (Funk), U.S. Pat. No. 6,386,635 (Gary), U.S. Pat. No. 6,042,093 (Garelick) and GB1244589 (Lindstrom).

In all of these cases, shock absorption is provided by a structure that is affixed to the boat hull or superstructure in some way, and the seat is affixed in turn to the shock-absorbing structure. The seat may typically further comprise a foam cushion or the like, which is carried on or fitted to the seat.

However, there are many powerboats , especially in the relatively modest price range, in which the seat is formed as part of the superstructure or affixed to the hull directly or indirectly, and in which the only provision for comfort of the occupants is a foam cushion or the like that lays on top of the seat. As noted above, such foam does little or nothing to absorb significant shocks.

Preferred embodiments of the present invention aim to provide a shock-absorbing device that may be used in such powerboats, to greatly improve comfort for the occupants.

According to the present invention, there is provided a powerboat seat comprising a seat frame and a removable seat cushion that may be supported on the seat frame, the powerboat seat further comprising a shock-absorbing device that is interposed between the seat frame and the seat cushion such that the shock-absorbing device is supported on the seat frame and the seat cushion is supported on the shock-absorbing device; wherein the shock-absorbing device comprises an upper panel having an external face that engages the seat cushion, a lower panel having an external face that engages the seat frame, a plurality of compression springs constrained between the upper and lower panels, and flexible retaining members connecting the upper and lower panels to constrain the compression springs between them whilst allowing limited relative vertical movement of the upper and lower panels at the front and the back of the panels: at least some of the compression springs being located towards the front and the back of the panels.

Preferably, said external faces are substantially parallel.

Preferably, said upper and lower panels are formed with blind recesses on inner surfaces of the panels, to receive and locate ends of the compression springs.

Preferably, four said compression springs are provided in a symmetrical arrangement.

Preferably, said panels are of generally rectangular shape.

Preferably, said flexible retaining members comprise one or more flexible strap connecting said upper and lower panels.

Preferably, at least one channel is formed on at least one of said upper and lower panels and said flexible strap is located in said channel.

Preferably, at least one of said upper and lower panels is formed with at least one slot at one side of the panel and said flexible strap passes through said slot.

Said flexible retaining members may comprise one or more flexible strap in the form of a continuous loop that passes around both of said panels.

Said flexible retaining members may comprise one or more flexible strap in the form of a discrete length with end parts that engage with one or both of said panels.

The shock-absorbing device may be supported on the seat frame and/or the seat cushion may be supported on the shock-absorbing device in a loose-laid manner, without the use of securing means to engage the shock-absorbing device with the seat frame and/or the seat cushion.

The shock-absorbing device may be supported on the seat frame and/or the seat cushion may be supported on the shock-absorbing device, with securing means to engage the shock-absorbing device with the seat frame and/or the seat cushion, the securing means being operable by hand without the use of tools or with the use of simple tools such as a screwdriver or spanner

The invention extends to a powerboat provided with at least one seat according to any of the preceding aspects of the invention.

In another aspect, the invention provides a method of modifying a powerboat seat comprising a seat frame and a removable seat cushion supported on the seat frame, the method comprising the steps of removing the seat cushion from the seat frame and interposing a shock-absorbing device between the seat frame and the seat cushion such that the shock-absorbing device is supported on the seat frame and the seat cushion is supported on the shock-absorbing device, wherein the shock-absorbing device comprises an upper panel having an external face that engages the seat cushion, a lower panel having an external face that engages the seat frame, a plurality of compression springs constrained between the upper and lower panels, and flexible retaining members connecting the upper and lower panels to constrain the compression springs between them whilst allowing limited relative vertical movement of the upper and lower panels at the front and the back of the panels: at least some of the compression springs being located towards the front and the back of the panels.

In such a method, the powerboat seat may be in accordance with any of the preceding aspects of the invention.

For a better understanding of the invention, and to show how embodiments of the same may be carried into effect, reference will now be made, by way of example, to the accompanying diagrammatic drawings, in which:

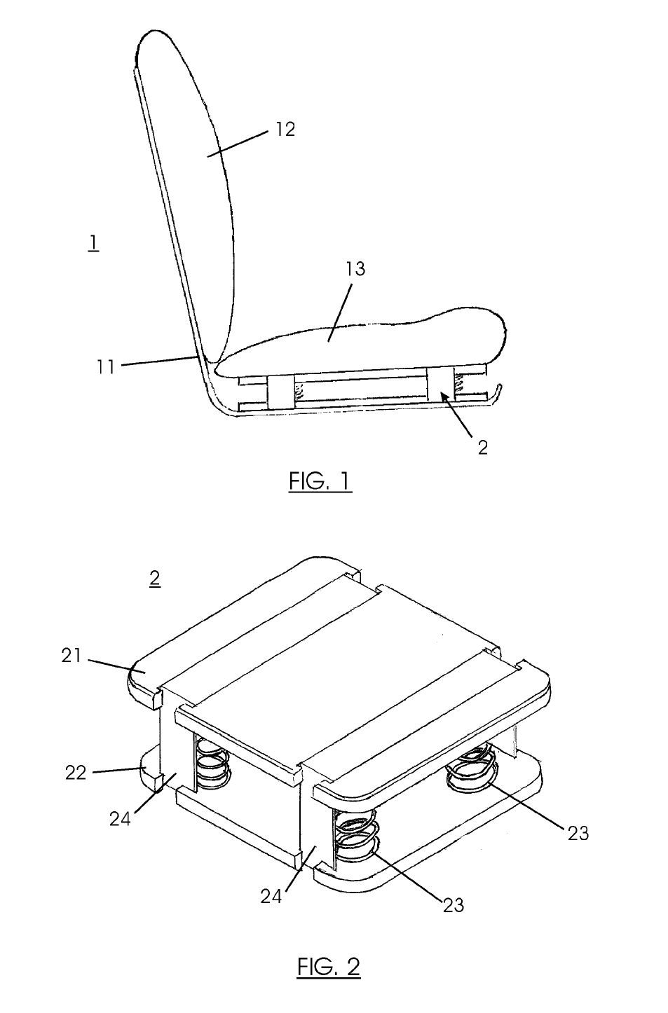

FIG. 1 is a cross-sectional view of a boat seat with a shock-absorbing device installed;

FIG. 2 is a perspective view of the shock-absorbing device; and

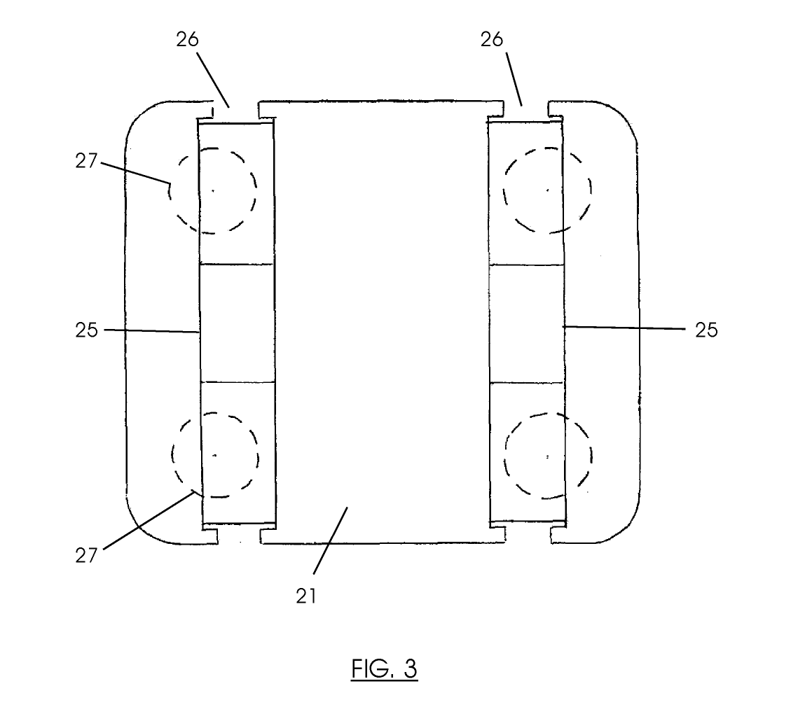

FIG. 3 is a plan view of an upper panel of the shock-absorbing device.

In the figures, like references denote like or corresponding parts.

It is to be understood that the various features that are described in the following and/or illustrated in the drawings are preferred but not essential Combinations of features described and/or illustrated are not considered to be the only possible combinations. Unless stated to the contrary, individual features may be omitted, varied or combined in different combinations, where practical.

The boat seat 1 that is shown in FIG. 1 comprises a seat frame 11, which may be typically of glass reinforced plastics, a seat back cushion 12 secured to the seat frame 11 and a seat cushion 13 that ordinarily sits on the seat frame 11. The seat frame 11 may be formed as part of the superstructure of a boat, or affixed to the boat hull or superstructure in any convenient way. For example, the seat frame 11 may be mounted on a pedestal (not shown) that is secured to the boat hull.

In FIG. 1, the seat cushion 13, which is typically a removable item, has been removed from the seat frame 11 and, in its place, a shock-absorbing device 2 has been placed on the seat frame. The seat cushion 13 has then been replaced on top of the shock-absorbing device 2.

The shock-absorbing device 2 is shown in more detail in FIG. 2. It comprises an upper flat panel 21 and a lower flat panel 22, between which four compression springs 23 are constrained. The compression springs 23 are arranged symmetrically, one adjacent each of the four corners of the device 2. The assembly is held together by a pair of flexible retaining straps 24 that pass around the panels 21, 22, to hold the springs 23 under a degree of compression.

In this example, the external faces of the panels 21 and 22 are substantially parallel. Alternatively, they may be inclined to one another such that the shock-absorbing device 2 is tapered. To this end, one of the straps 24 may be shorter than the other. The lengths of the straps 24 may be adjustable.

The upper panel 21 is shown in FIG. 3. On its upper surface, it is formed with a pair of channels 25 that receive the straps 24, such that the straps do not protrude above the upper surface of the panel 21. Slots 26 at the end of the recesses 25 serve to locate the straps 24. On the under-surface of the upper panel 21 there are formed four circular blind recesses, each of which receives a respective end of one of the springs 23. The upper face of the panel 21 is provided with a high-friction surface or coating. The lower panel 22 is of a similar construction to the upper panel 21, having a high-friction lower surface or coating on its lower face.

The illustrated device 2 provides an inexpensive and effective way to modify an existing seat in a powerboat , to provide significant shock absorption. The seat cushion 13 is simply lifted off the seat frame 11. The device 2 is placed on the seat frame 11 and then the seat cushion 13 is replaced on top of the device 2. In use, shock loads are transferred through the seat cushion 13 to the upper support panel 21 then via the springs 23 to the lower support panel 22, and then onwards to the underlying boat structure. The springs 23 deform and so soften the motion of the upper support panel 21, this deformation being relative to the applied shock load.

Various features and advantages of the illustrated shock-absorbing device 2 are as follows.

The device 2 can be retro-fitted to seats without the need for any structural modification to the seat, its components or surrounds.

Installation is easy. The device 2 is simply placed, either way up, between the existing seat cushion 13 and the seat base, without the need for fixings. However, if desired, the device 2 could be secured to the seat frame 11 by conventional fixings (such as screws, bolts or hinges) or by manually operable fixings such as clamps or thumbscrews, such that the device 2 is readily removable. The seat cushion 13 could likewise be removably secured to the device 2. Prior to modification by inserting the device, the seat cushion may likewise be removably secured to the seat frame 11.

Thus, the term ‘removable’ includes both loose-laid fashion and simple fixings that are operable by hand without the use of tools or with the use of simple tools such as a screwdriver or spanner

In the illustrated embodiment, the device construction of upper and lower rigid panels 21, 22 with high-friction, slip-resistant external surfaces minimises relative movement between the seat cushion 13 and upper panel 21, and between the lower panel 22 and the seat frame 11. This minimises the need for any mechanical fixing to the seat frame 11, as the device 2 may be retained in place by its own weight, the weight of the cushion 13 above, the seat sides and back. The rigidity of the upper and lower panels 21, 22 ensures that the seat cushion 13 is fully supported over its base area, and so does not deform in use any differently from when the device 2 is not installed.

The springs 23 are simply located in the circular blind recesses 27, retained by their own partial compression and reactive resistance of the straps 24, to provide a flexible, strong and homogeneous assembly without the need for spring guide channels or conventional fixings such as screws, bolts, welding or glue.

Assembly of the device 2 is simple. The loosely assembled device, with springs 23 inserted, only needs compressing lightly to the extent that the straps 24 can be fitted. The straps 24 are retained laterally by passing through the edge slots 26 and vertically in the recessed channels 25 to minimise their abrasion from surrounding structure. No further assembly operations are required.

The upper and lower panels 21, 22 may be identical and any size or shape up to, for example, 3 m×2 m×30 mm thick. They may comprise, for example, any plastics material (including fibre reinforced plastics), metal, wood or other rigid material.

The springs 23 may be manufactured from any metal and any size up to 200 mm diameter and 300 mm free length and any spring rate up to 200 N/mm to cater for differing operational conditions.

The straps 24 may be made from polypropylene, polyester, nylon or other natural or man-made flexible fibre. They may be conveniently formed as continuous loops. Alternatively, they may be provided with end parts that engage with either of the upper and lower panels 21, 22 to locate and fix the ends of the straps 24.

Different numbers of springs 23 and straps 24 may be provided, in different configurations.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivates) indicates one feature or more that is preferred but not essential.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A powerboat seat comprising a seat frame and a removable seat cushion that may be supported on the seat frame, the powerboat seat further comprising a shock-absorbing device that is interposed between the seat frame and the seat cushion such that the shock-absorbing device is supported on the seat frame and the seat cushion is supported on the shock-absorbing device, wherein the shock-absorbing device comprises an upper panel having an external face that engages the seat cushion, a lower panel having an external face that engages the seat frame, a plurality of compression springs constrained between the upper and lower panels, and flexible retaining members connecting the upper and lower panels to constrain the compression springs between them whilst allowing limited relative vertical movement of the upper and lower panels at the front and the back of the panels: at least some of the compression springs being located towards the front and the back of the panels.

2. A powerboat seat according to claim 1, wherein said external faces are substantially parallel.

3. A powerboat seat according to claim 1, wherein said upper and lower panels are formed with blind recesses on inner surfaces of the panels, to receive and locate ends of the compression springs.

4. A powerboat seat according to claim 1, wherein four said compression springs are provided in a symmetrical arrangement.

5. A powerboat seat according to claim 1, wherein said panels are of generally rectangular shape.

6. A powerboat seat according to claim 1, wherein said flexible retaining members comprise one or more flexible strap connecting said upper and lower panels.

7. A powerboat seat according to claim 6, wherein at least one channel is formed on at least one of said upper and lower panels and said flexible strap is located in said channel.

8. A powerboat seat according to claim 6, wherein at least one of said upper and lower panels is formed with at least one slot at one side of the panel and said flexible strap passes through said slot.

9. A powerboat seat according to claim 6, wherein said flexible retaining members comprise one or more flexible strap in the form of a continuous loop that passes around both of said panels.

10. A powerboat seat according to claim 6, wherein said flexible retaining members comprise one or more flexible strap in the form of a discrete length with end parts that engage with one or both of said panels.

11. A powerboat seat according to claim 1, wherein the shock-absorbing device is supported on the seat frame and/or the seat cushion is supported on the shock-absorbing device in a loose-laid manner, without the use of securing means to engage the shock-absorbing device with the seat frame and/or the seat cushion.

12. A powerboat seat according to claim 1, wherein the shock-absorbing device is supported on the seat frame and/or the seat cushion is supported on the shock-absorbing device, with securing means to engage the shock-absorbing device with the seat frame and/or the seat cushion, the securing means being operable by hand without the use of tools or with the use of simple tools such as a screwdriver or spanner.

13. A method of modifying a powerboat seat comprising a seat frame and a removable seat cushion supported on the seat frame, the method comprising the steps of removing the seat cushion from the seat frame and interposing a shock-absorbing device between the seat frame and the seat cushion such that the shock-absorbing device is supported on the seat frame and the seat cushion is supported on the shock-absorbing device, wherein the shock-absorbing device comprises an upper panel having an external face that engages the seat cushion, a lower panel having an external face that engages the seat frame, a plurality of compression springs constrained between the upper and lower panels, and flexible retaining members connecting the upper and lower panels to constrain the compression springs between them whilst allowing limited relative vertical movement of the upper and lower panels at the front and the back of the panels: at least some of the compression springs being located towards the front and the back of the panels.

14. (canceled)

15. A powerboat provided with at least one seat according to claim 1.

16.-17. (canceled)
